(19) United States
(12) Patent Application Publication
(10) Pub. No.: US 2019/0146734 A1
(43) Pub. Date: May 16, 2019

(54) INFORMATION PROCESSING APPARATUS, INFORMATION PROCESSING SYSTEM, INFORMATION TERMINAL DEVICE AND INFORMATION PROCESSING METHOD USING CODE SYMBOLS

(71) Applicant: TOSHIBA TEC KABUSHIKI KAISHA, Tokyo (JP)

(72) Inventor: Toshiki Takeishi, Mishima Shizuoka (JP)

(73) Assignee: TOSHIBA TEC KABUSHIKI KAISHA, Tokyo (JP)

(21) Appl. No.: 16/003,502

(22) Filed: Jun. 8, 2018

(30) Foreign Application Priority Data
Nov. 14, 2017 (JP) 2017-219186

(51) Int. Cl. G06F 3/12; H04N 1/00

(52) U.S. Cl. CPC G06F 3/1236; G06F 3/1204; H04N 1/00411; H04N 2201/0041; H04N 2201/0094; H04N 2201/0055; H04N 2201/0036; G06F 3/1292

(57) ABSTRACT

An information processing apparatus is described. The information processing apparatus executes an information process while transmitting and receiving data to and from an information terminal device in response to a request from the information terminal device. The information processing apparatus includes a communication module configured to wirelessly communicate with the information terminal device, an output module configured to output an image, and a controller configured to control the output module to output an image containing a code symbol which can be optically read. The code symbol indicates connection information for wireless connection from the information terminal device to the communication module and identification information for identifying the information processing apparatus for data transmission.

### CROSS-REFERENCE TO RELATED APPLICATION

This application is based upon and claims the benefit of priority from Japanese Patent Application No. 2017-219186, filed Nov. 14, 2017, the entire contents of which are incorporated herein by reference.

### FIELD

Some embodiments described herein relate generally to an information processing apparatus, an information processing system, an information terminal device and an information processing method.

### BACKGROUND

An information processing apparatus such as a printer or the like is connected with an information terminal device such as a mobile terminal through wireless communication using a Wi-Fi Direct® Technology, and the information processing apparatus has a function of executing an information process in response to a request from the information terminal device.

The information processing apparatus of such a type displays a screen in which connection information such as a SSID (service set identifier) and passphrase for wireless connection with the information terminal device is shown as character strings. Then, a user manually inputs the connection information with the information terminal device.

Furthermore, the wireless connection based on the connection information is performed using the information terminal device as an access point. For this reason, in order to perform data transmission between the information terminal device and the information processing apparatus using the wireless connection, identification information such as an IP address for identifying the information processing apparatus is required. The identification information is conventionally acquired by searching via the wireless connection after wireless connection in the information terminal device.

However, depending on network environment of the information processing apparatus, there is a case in which a large amount of identification information is acquired through the above search. In this case, the information terminal device presents a list of the identification information to the user, and allows the user to designate the identification information of the information processing apparatus executing the information process. For this reason, the burden on the user is increased, and that the user cannot designate appropriate identification information without knowing the corresponding identification information may occur.

Under such circumstances, it is desired to reduce a burden on the user for realizing the wireless connection between the information processing apparatus and the information terminal device and for enabling data transmission between both apparatuses.

### DESCRIPTION OF THE DRAWINGS

FIG. 1 is a block diagram illustrating a schematic configuration of an information processing system and circuit configurations of main portions of an MFP and a smartphone according to at least one embodiment;

FIG. 2 is a flowchart for depicting procedures of an information process for displaying a presentation screen by a processor of the MFP shown in FIG. 1;

FIG. 3 is a diagram illustrating an example of the presentation screen;

FIG. 4 is a flowchart for depicting procedures of an information process according to an MFP cooperative application by a processor of the smartphone shown in FIG. 1; and

FIG. 5 is a flowchart for depicting procedures of the information process according to the MFP cooperative application by the processor of the smartphone shown in FIG. 1.

### DETAILED DESCRIPTION

In accordance with an embodiment, an information processing apparatus, which executes an information process while transmitting and receiving data to and from an information terminal device in response to a request from the information terminal device, the information processing apparatus comprises a communication module configured to wirelessly communicate with the information terminal device; an output module configured to output an image; and a controller configured to control the output module to output an image containing a code symbol which can be optically read, the code symbol indicating connection information for wireless connection from the information terminal device to the communication module and identification information for identifying the information processing apparatus for data transmission.

An example of at least one embodiment is described below with reference to the accompanying drawings. In at least one embodiment, an information processing system is described as an example in which a MFP (Multifunction Peripheral) is used as an information processing apparatus and a smartphone is used as an information terminal device. The contents of various information processes described below are merely examples, and various information processes capable of achieving the same result can be appropriately used.

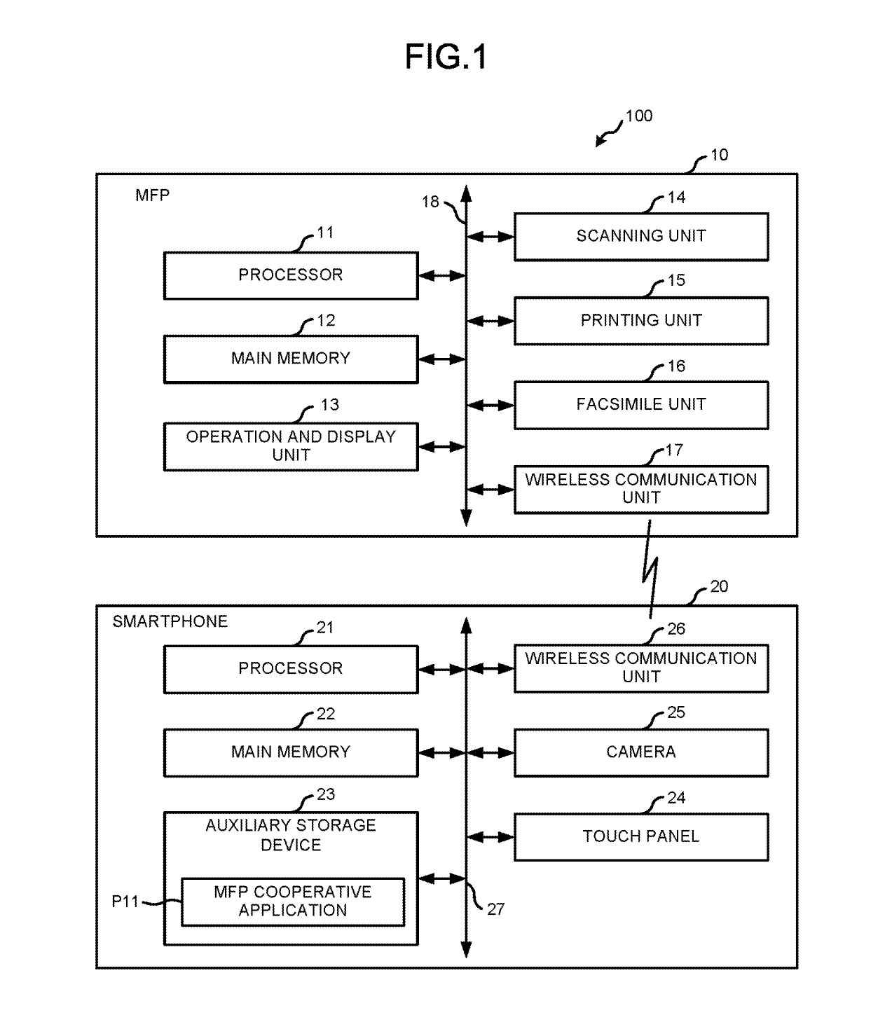

FIG. 1 is a block diagram illustrating a schematic configuration of the information processing system and configurations of main portions of the MFP and the smartphone according to the present embodiment.

An information processing system 100 includes a MFP 10 and a smartphone 20.

The MFP 10 includes a processor 11, a main memory 12, an operation and display unit 13, a scanning unit 14, a printing unit 15, a facsimile unit 16, a wireless communication unit 17 and a transmission path 18. The processor 11, the main memory 12, the operation and display unit 13, the scanning unit 14, the printing unit 15, the facsimile unit 16 and the wireless communication unit 17 are connected with each other via the transmission path 18.

In the MFP 10, the processor 11 and the main memory 12 are connected with each other via the transmission path 18 to constitute a computer for executing an information process for controlling the MFP 10. The MFP 10 may further include an auxiliary storage device connected to the transmission path 18, and the auxiliary storage device may act as an auxiliary storage portion of the computer. The auxiliary storage device is, for example, an EEPROM (electric erasable programmable read-only memory). The auxiliary storage device may also be a HDD (hard disc drive), a SSD (solid state drive) or the like.

The processor 11 acts as a central part of the computer. The processor 11 controls each section to realize various functions of the MFP 10 by executing an operating system and an application program.

The main memory 12 acts as a main storage portion of the computer. The main memory 12 includes a nonvolatile memory area and a volatile memory area. The main memory 12 stores the operating system and the application program in the nonvolatile memory area. The main memory 12 stores data necessary for the processor 11 to execute a process for controlling each section in the nonvolatile or volatile memory area. The main memory 12 uses the volatile memory area as a work area in which the data is appropriately rewritten by the processor 11.

The operation and display unit 13 inputs an operation by the user, and also performs display for presenting various information to the user. The operation and display unit 13 may appropriately include various operation devices and display devices such as a touch panel, a keyboard, a key switch, an LED lamp, or a liquid crystal display panel. However, at least one display device capable of displaying an arbitrary image is contained in the operation and display unit 13. The display device is an example of an output module that outputs an image.

The scanning unit 14 reads a document to generate image data indicating the document.

The printing unit 15 prints an image indicated by the image data on a recording paper.

The facsimile unit 16 performs various well-known processes for performing image communication conforming to a facsimile standard via a communication network such as PSTN (public switched telephone network).

The wireless communication unit 17 performs a well-known process for wirelessly communicating with an arbitrary device having a wireless communication function such as the smartphone 20. The wireless communication unit 17 is an example of a communication module or a first communication module that wirelessly communicates with the smartphone 20 as the information terminal device. The wireless communication unit 17 may be, for example, a well-known device conforming to the standard such as IEEE802.11g or the like.

The transmission path 18 includes an address bus, a data bus, a control signal line, and the like, and transmits data and control signals transmitted and received among the contracted sections.

The smartphone 20 includes a processor 21, a main memory 22, an auxiliary storage device 23, a touch panel 24, a camera 25, a wireless communication unit 26, and a transmission path 27. The processor 21, the main memory 22, the auxiliary storage device 23, the touch panel 24, the camera 25 and the wireless communication unit 26 are connected with each other via the transmission path 27.

In the smartphone 20, the processor 21, the main memory 22, and the auxiliary storage device 23 are connected with each other by the transmission path 27 to constitute a computer that performs an information process for controlling the smartphone 20.

The processor 21 acts as a central part of the computer. The processor 21 controls each section to realize various functions of the smartphone 20 by executing an operating system and an application program.

The main memory 22 acts as a main memory portion of the computer. The main memory 22 includes a nonvolatile memory area and a volatile memory area. The main memory 22 stores the operating system and the application program in the nonvolatile memory area. The main memory 22 stores data necessary for the processor 21 to execute a process for controlling each section in the nonvolatile or volatile memory area. The main memory 22 uses the volatile memory area an a work area in which the data is appropriately rewritten by the processor 21.

The auxiliary storage device 23 acts as an auxiliary storage portion of the computer. The auxiliary storage device 23 is, for example, an EEPROM. The auxiliary storage device 23 stores data used by the processor 21 to perform various processes and data generated by the processes executed by the processor 21. The auxiliary storage device 23 stores the application program.

One of the application programs stored in the auxiliary storage device 23 is an information processing program (hereinafter, referred to as a MFP cooperative application) P11 for realizing an information process for an operation described later in cooperation with the MFP 10. Typically, however, the MFP cooperative application P11 is written into the auxiliary storage device 23 by being downloaded via an Internet in response to an operation by the user of the smartphone 20. The transfer of the smartphone 20 to the user of the smartphone 20 is performed in a state in which a MFP cooperative application P11 is not stored in the auxiliary storage device 23. However, the smartphone 20 in a state in which the MFP cooperative application P11 is stored in the auxiliary storage device 23 may be transferred to the user of the smartphone 20.

The touch panel 24 functions as an input device and a display device of the smartphone 20.

The camera 25 generates image data corresponding to a subject existing within the field of view of the mounted optical system.

The wireless communication unit 26 performs a well-known process for performing a wireless communication with an arbitrary device having the wireless communication function such as the MFP 10. The wireless communication unit 26 is an example of a second communication module that wirelessly communicates with the MFP 10 as the information processing apparatus. As the wireless communication unit 26, a well-known device conforming to the same standard as the wireless communication unit 17 may be provided.

The transmission path 27 includes an address bus, a data bus, a control signal line, and the like, and transmits the data and the control signal transmitted and received between the connected sections.

The operation of the information processing system configured as described above is described below.

In the MFP 10, the processor 11 controls each section of the MFP 10 to realize a printing function, a copying function, a scanning function, a facsimile function and the like in the same manner as in the existing MFP of the same type. Then, if the MFP 10 is prepared to receive the operation by the user, the processor 11 confirms whether or not display of a presentation screen for presenting connection information is instructed. In such a situation, in a case in which the user wants to execute a job with the MFP 10 through the cooperation between the smartphone 20 and the MFP 10, the user instructs the display of the presentation screen through a predetermined operation on the operation and display unit 13, for example.

The processor 11 receiving this instruction starts the following information process.

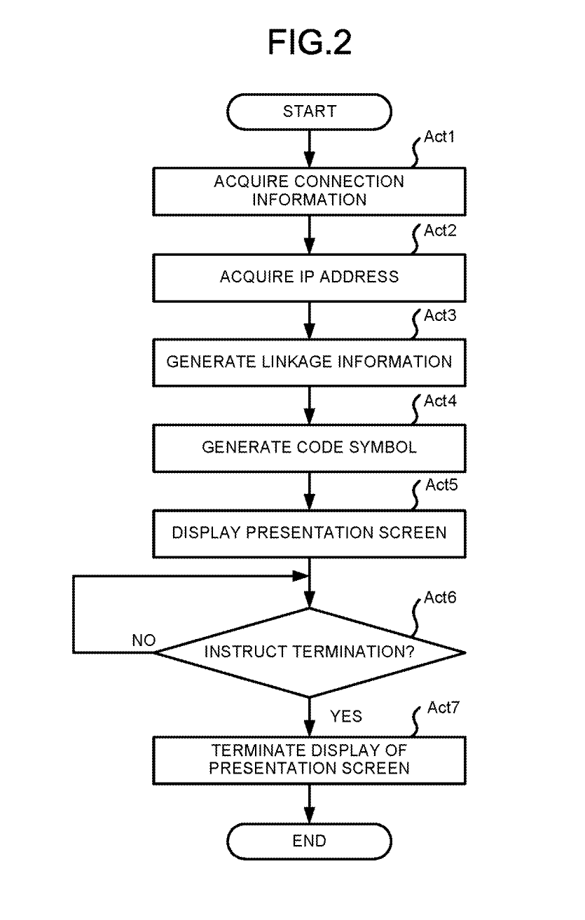

FIG. 2 is a flowchart for depicting procedures of the information process for displaying the presentation screen by the processor 11. The processor 11 executes the information process based on the application program stored in the main memory 12.

In Act 1, the processor 11 acquires the connection information. Specifically, the processor 11 reads out the connection information stored in the nonvolatile area of the main memory 12. The connection information is required when the wireless communication unit 17 establishes a wireless connection with another wireless terminal. Here, the connection information includes SSID and passphrase. The processor 11 writes the connection information assigned to the wireless communication unit 17 into the main memory 12 by an information process (not shown) different from that shown in FIG. 2. At this time, if another connection information is already stored in the main memory 12, the processor 11 overwrites using the new connection Information.

In Act 2, the processor 11 acquires an IP address. Specifically, the processor 11 reads out the IP address stored in the nonvolatile area of the main memory 12. The IP address is used for identifying the MFP 10 in data transmission according to the Internet protocol. The processor 11 writes the IP address assigned to the MFP 10 into the main memory 12 by an information process (not shown) different from that shown in FIG. 2. At this time, if another IP address is already stored in the main memory 12, the processor 11 overwrites using the new IP address.

In Act 3, the processor 11 generates linkage information. The linkage information is used for notifying the smartphone 20 of the connection information and the IP address. Here, the linkage information indicates a character string of the following format:

WIFI:S:XXXX;T:YYYY;I:ZZZZ;;

The processor 11 generates the linkage information as a character string in which the SSID and passphrase included in the connection information acquired in Act 1 and the IP address acquired in Act 2 are set respectively in place of “XXXX” , “YYYY” and “ZZZZ”.

In Act 4, the processor 11 generates a code symbol representing the linkage information. The code symbol indicates that the linkage information can be optically read according to a predetermined standard. The standard of the code symbol may be arbitrary as long as the code symbol can represent all the linkage information, and here, it is assumed that a QR code® Technology is used, for example.

In Act 5, the processor 11 displays the presentation screen on the operation and display unit 13. The presentation screen shows the code symbol for presenting the connection information to the user.

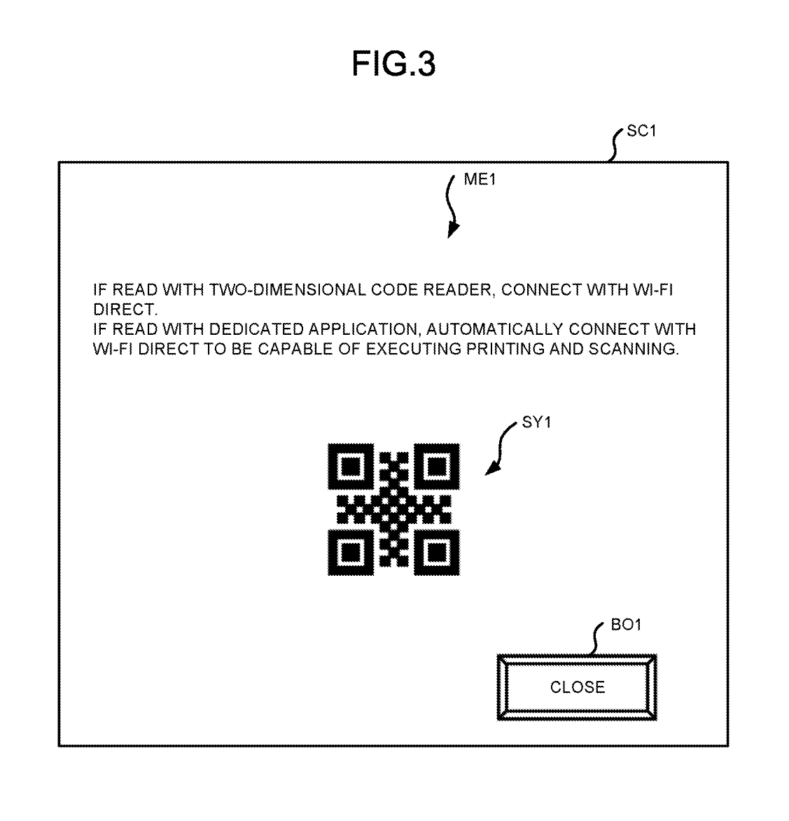

FIG. 3 is a diagram illustrating an example of the presentation screen.

The presentation screen SC1 shown in FIG. 3 includes a text message ME1, a code symbol SY1 and a button BO1.

The text message ME1 indicates how to use the code symbol SY1. The code symbol SY1 is generated in Act 4. The button BO1 is used to input an instruction to terminate the display of the presentation screen SC1.

The display on the presentation screen SC1 is an example of output of an image including an optically readable code symbol indicating the linkage information. Thus, the processor 11 executes the information process based on the information processing program, and in this way, the computer having the processor 11 as the central part functions as a control module.

In Act 6, the processor 11 stands by until an instruction to terminate the display of the presentation screen SC1 is input. Then, if the user instructs the termination of the display by touching the button BO1, the processor 11 determines “Yes” in Act 6 and proceeds to the process in Act 7.

In Act 7, the processor 11 terminates the display of the presentation screen SC1 on the operation and display unit 13. The processor 11 then terminates the information process shown in FIG. 2.

If the user wants to use the MFP 10 to execute a job through cooperation with the smartphone 20, the user operates the touch panel 24 so as to instruct execution of the MFP cooperative application P11. In response to the operation, the processor 21 executes the following information process according to the MFP cooperative application P11.

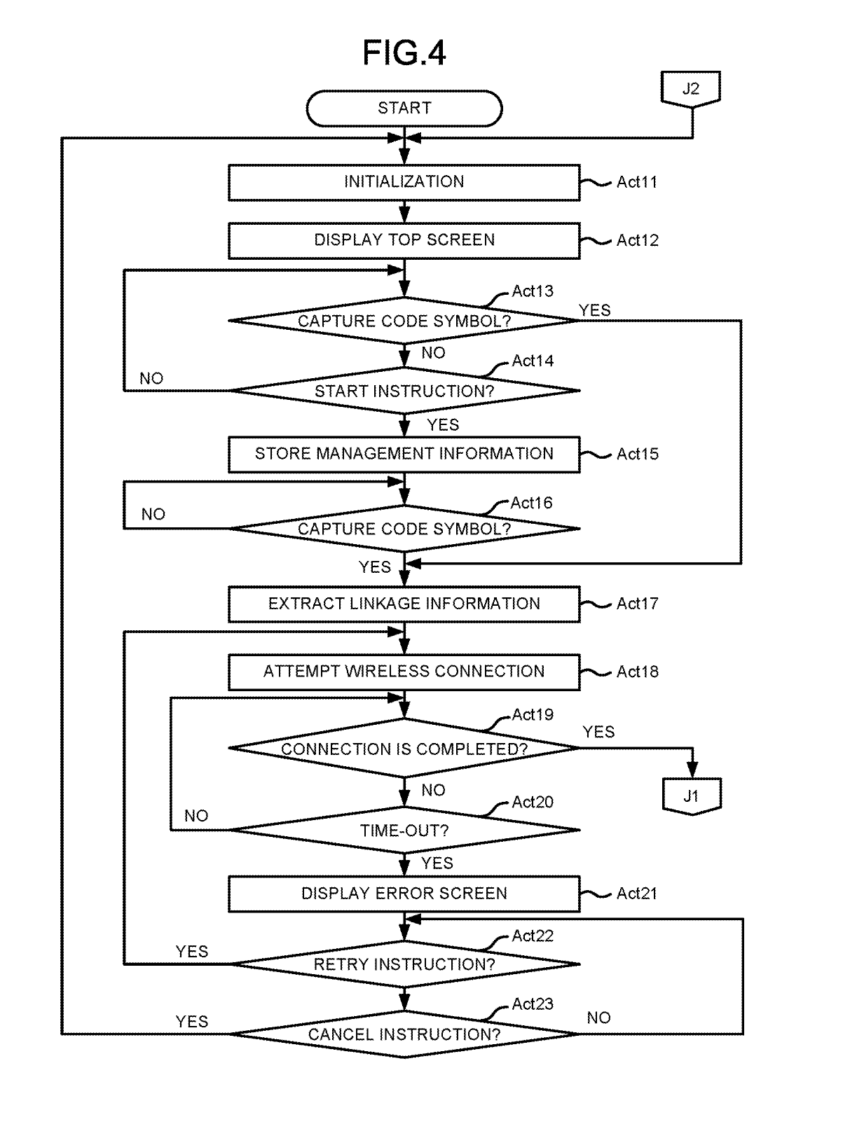

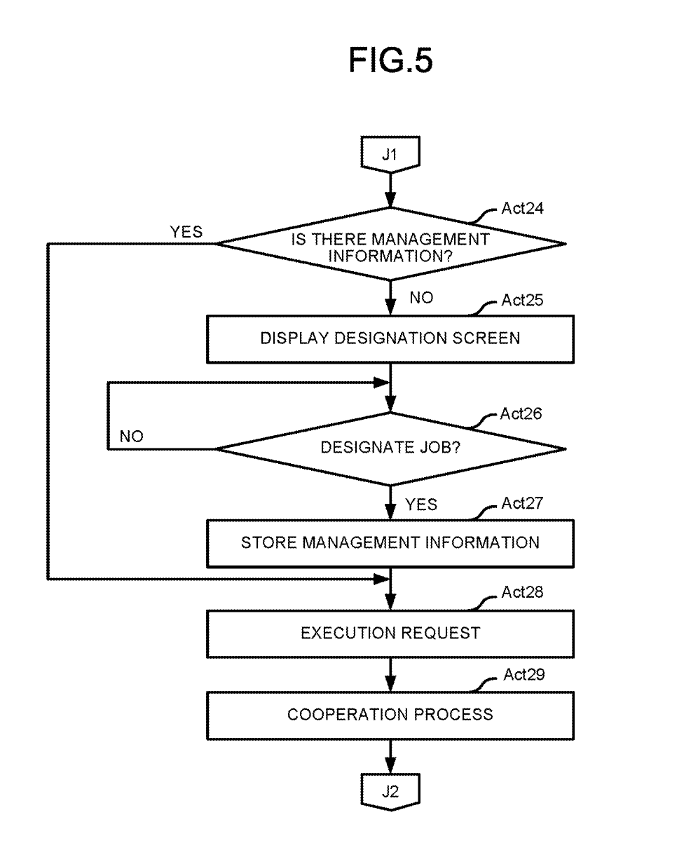

FIG. 4 and FIG. 5 are flowcharts for depicting procedures of the information process according to the MFP cooperative application P11 by the processor 21.

In Act 11 in FIG. 4, the processor 21 performs initialization such as clearing management information described later.

In Act 12, the processor 21 displays a top screen on the touch panel 24. On the top screen, a text message for guiding the camera 25 to capture the code symbol SY1 displayed on the MFP 10 is shown. The top screen shows a button for inputting an instruction to start setting a job to be executed by the MFP 10.

In Act 13, the processor 21 confirms whether or not the code symbol SY1 is captured by the camera 25. Then, if the code symbol SY1 is not captured, the processor 21 determines No in Act 13, and proceeds to the process in Act 14.

In Act 14, the processor 21 confirms whether or not the instruction to start setting the job is issued. Then, if the operation for the start instruction is not performed, the processor 21 determines No in Act 14, and returns to the process in Act 13.

In this way, the processor 21 stands by until the code symbol SY1 is captured or the start is instructed in Act 13 and Act 14. Then, if the start is instructed by the user touching the above-described button on the top screen, the processor 21 determines Yes in Act 14 and proceeds to the process in Act 15.

In Act 15, the processor 21 stores the management information in the main memory 22 or the auxiliary storage device 23. Specifically, the processor 21 receives designation by the user on the content of the job to be executed by the MFP 10, generates the management information for managing the content thereof, and stores the management information in the main memory 22 or the auxiliary storage device 23. For example, if a job for the smartphone 20 to acquire the image data generated by the scanning function of the MFP 10 is designated, the management information includes a function code assigned to the scanning function, and path information indicating a storage destination of the image data in the smartphone 20. For example, if a job for printing the image data stored in the smartphone 20 by the printing function of the MFP 10 is designated, the management information includes a function code assigned to the printing function and path information for specifying the image data to be printed.

In Act 16, the processor 21 stands by until the code symbol SY1 is captured by the camera 25. Then, if the code symbol SY1 is captured by the camera 25, the processor 21 determines Yes in Act 16 and proceeds to the process in Act 17. If the code symbol SY1 is captured by the camera 25 in the standby state in Act 13 and Act 14, the processor 21 determines Yes in Act 13, and then proceeds to the process in Act 17 without executing the processes in Act 15 and Act 16. The capturing of the code symbol SY1 by the camera 25 corresponds to the optical reading of the code symbol SY1. Therefore, the camera 25 is an example of a reading module.

In Act 17, the processor 21 captures the code symbol SY1, analyzes the image data obtained by the camera 25, and extracts the linkage information indicated by the code symbol SY1. The processor 21 temporarily stores the extracted linkage information in the main memory 22 or the auxiliary storage device 23.

In Act 18, the processor 21 instructs the wireless communication unit 26 to perform the wireless connection using the connection information contained in the extracted linkage information. Then, the wireless communication unit 26 attempts to perform the wireless connection according to predetermined procedures. For example, a method conforming to Wi-Fi Direct® Technology may be applied as the above procedures. The procedure is performed between the wireless communication unit 26 and the wireless communication unit 17 of the MFP 10 by containing the SSID included in the connection information in a connection request from the wireless communication unit 26. In this procedure, the wireless connection between the wireless communication unit 26 and the wireless communication unit 17 is established after authentication using the pass phrase included in the above connection information.

In Act 19, the processor 21 confirms whether or not the wireless connection is established. If the wireless connection is not established, the processor 21 determines No in Act 19, and proceeds to the process in Act 20.

In Act 20, the processor 21 confirms whether or not allowable time for establishing the wireless connection has elapsed. If the time has not elapsed, the processor 21 determines No in Act 20 and returns to the process in Act 19.

Thus, in Act 19 and Act 20, the processor 21 stands by until the wireless connection is established or the time has elapsed. Then, before the wireless connection is established, if the allowable time has elapsed since the start of the connection in Act 18, the processor 21 determines Yes in Act 20 as a time-out, and proceeds to the process in Act 21.

In Act 21, the processor 21 displays an error screen for notifying the user that the wireless connection fails on the touch panel 24. On the error screen, a retry button for inputting an instruction to retry the wireless connection and a cancel button for inputting an instruction to cancel the present MFP cooperation are displayed. If the user wants to retry the wireless connection, the user needs to touch the retry button, contrarily, if the user wants to cancel the current MFP cooperation, the user needs to touch the cancel button.

In Act 22, the processor 21 confirms whether or not the retry instruction is issued. Then, if the retry instruction is not issued, the processor 21 determines No in Act 22, and proceeds to the process in Act 23.

In Act 23, the processor 21 confirms whether or not a cancel instruction is issued. Then, if the cancel instruction is not issued, the processor 21 determines No in Act 23, and returns to the process in Act 22.

Thus, the processor 21 stands by until the retry instruction or the cancel instruction is issued in Act 22 and Act 23. Then, if the retry instruction is issued, for example, by touching the retry button, the processor 21 determines Yes in Act 22 and repeats the processes subsequent to Act 18 in the same manner as described above. As a result, the wireless connection is retried.

On the other hand, if the cancel instruction is issued, for example, by touching the cancel button, the processor 21 determines Yes in Act 23 and returns to the process in Act 11, i.e., returns to the initial state.

If the wireless connection can be normally established in the standby state of Act 19 and Act 20, the processor 21 determines Yes in Act 19, and proceeds to the process in Act 24 in FIG. 5.

In Act 24, the processor 21 confirms whether or not the management information is stored in the main memory 22 or the auxiliary storage device 23. Since the management information is cleared due to the initialization in Act 11 in FIG. 4, if Act 15 is not executed, the management information is not stored in the main memory 22 or the auxiliary storage device 23. In other words, the processor 21 confirms whether or not a setting of the job to be executed is completed in Act 24 in FIG. 5. Such confirmation may be performed using a flag. Then, if the management information is not stored, the processor 21 determines No in Act 24, and proceeds to the process in Act 25.

In Act 25, the processor 21 displays a designation screen on the touch panel. The designation screen is used for receiving the designation by the user on the content of the job to be executed. In this designation screen, the user designates the content of the job to be executed.

In Act 26, the processor 21 stands by until the job is designated. Then, the processor 21 performs an operation of designating the content of the job, determines Yes if the operation is input by the user through the touch panel 24, and then proceeds to the process in Act 27.

In Act 27, the processor 21 generates the management information for managing the content of the designated job and stores it in the main memory 22 or the auxiliary storage device 23. After this, the processor 21 proceeds to the process in Act 28. If the management information is already stored, the processor 21 determines Yes in Act 24, and proceeds to the process in Act 28 without executing the processes in Act 25 to Act 27.

In Act 28, the processor 21 requests the MFP 10 via the wireless connection to execute the job having the content indicated in the management information. In other words, in a case of proceeding to the process in Act 27 from Act 24, the processor 21 requests the MFP 10 to execute the information process using the IP address indicated by the captured code symbol SY1 in response to capturing of the code symbol SY1. Thus, the processor 21 executes the information process based on the MFP cooperative application P11, and in this way, the computer having the processor 21 as the central part functions as a request module.

In the MFP 10, if the wireless communication unit 17 receives such a request, the processor 11 controls each section to start the job in response to the request. The job executed by the MFP 10 includes various information processes such as generation of the image data or conversion of the image data to the print data. The MFP 10 executes the information processes by executing the job.

In Act 29, the processor 21 executes a process in cooperation with the job performed in the MFP 10.

Specifically, if the management information includes the function code assigned to the scanning function and the path information indicating the storage destination of the image data in the smartphone 20, the processor 21 requests the MFP 10 to execute the scanning function. Then, the processor 21 stores the image data transmitted from the MFP 10 via the wireless connection in the store destination specified by the above path information. The processor 21 confirms that the image data is transmitted from the MFP 10 if the IP address of the transmission source of the image data transmitted through the wireless connection matches with the IP address included in the linkage information. If the management information includes the function code assigned to the printing function and the path information for specifying the image data to be printed, the processor 21 requests the MFP 10 to execute the printing function. Then, the processor 21 transmits the image data specified by the above-mentioned path information to the MFP 10 using the wireless connection. The processor 21 uses the IP address included in the linkage information as the address of the transmission destination at the time of transmitting the image data.

Then, if the job in the MFP 10 and the process associated with the job are completed, the processor 21 returns to the process in Act 11 in FIG. 4, i.e., returns to the initial state.

As described above, according to the information processing system 100, when the code symbol SY1 displayed by the MFP 10 is captured by the smartphone 20, the smartphone 20 can acquire the connection information for the wireless connection and the IP address for data transmission. Therefore, in order to enable data transmission between the MFP 10 and the smartphone 20 via the wireless connection, the user may capture the code symbol SY1 with the camera 25. As a result, the burden is reduced as compared with a case in which the connection information is manually input or the IP address of the MFP 10 is selected from an IP address list.

According to the information processing system 100, if the user designates the content of the job to be executed and the cede symbol SY1 is captured, after the wireless connection is established, the designated job is automatically executed by cooperation between the MFP 10 and the smartphone 20. Therefore, the user can quickly complete a series of operations for executing the job without waiting for establishment of the wireless connection.

In the present embodiment, the following various modifications is applicable.

As the information processing apparatus, another arbitrary apparatus such as a printer, a scanner, a facsimile apparatus or the like may be applicable.

As the information terminal device, another arbitrary device such as a tablet terminal or a personal computer may be applicable.

The presentation screen including the code symbol SY1 may be output by another method such as printing on a recording paper, for example.

As the identification information for identifying the MFP 10 at the time of the data transmission, arbitrary information other than the IP address may be applicable.

After terminating the process in Act 15 in FIG. 4, the processor 21 may return to the standby state in Act 13 and Act 14. In this case, if there is a possibility that the flow proceeds again to the process in Act 15, the processor 21 overwrites the already stored management information with the new management information. In other words, the setting of the job may be performed newly.

The format of the linkage information may be changed as appropriate.

Each function realized by the processor 11 or the processor 21 through the information process may be partially or entirely realized by hardware such as a logic circuit which executes an information process which is not based on a program. In addition, each of the above-described functions may also be realized by combining software control with the above hardware such as the logic circuit.

While certain embodiments have been described, these embodiments have been presented by way of example only, and are net intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An information processing apparatus, which executes an information process while transmitting and receiving data to and from an information terminal device in response to a request from the information terminal device, the information processing apparatus comprising:
a first communication circuit configured to wirelessly communicate with the information terminal device;
an output circuit configured to output an image; and
a controller configured to control the output circuit to output an image containing a code symbol which can be optically read, the code symbol indicating connection information for wireless connection from the information terminal device to the first communication circuit and identification information for identifying the information processing apparatus for data transmission,
the first communication circuit arranged to have a second communication circuit of the information terminal device establish wireless connection with the first communication circuit using the connection information indicated by a read code symbol in response to reading of the code symbol after execution of the information process is instructed.

2. The information processing apparatus according to claim 1, wherein the information processing apparatus is at least one of a multifunction peripheral, a printer, a scanner, or a facsimile apparatus.

3. The information processing apparatus according to claim 1, wherein the connection information includes a service set identifier and a passphrase.

4. The information processing apparatus according to claim 1, wherein the output circuit includes a display configured to display the image.

5. The information processing apparatus according to claim 1, wherein the controller is configured to control a screen of the output circuit to display a message indicating how to use the code symbol.

6. The information processing apparatus according to claim 5, wherein the controller is configured to control a screen of the output circuit to display a button prompting a user to terminate the display of the message.

7. The information processing apparatus according to claim 1, wherein
the controller is configured to represent the code symbol in a format of a character string WIFI:S:XXXX;T:YYYY;I:ZZZZ, wherein a first character string indicating identification information of the first communication circuit is set in place of XXXX, a second character string indicating a pass phrase is set in place of YYYY, and identification information for identifying the information processing apparatus is set in place of ZZZZ.

8. An information processing system, comprising an information terminal device and an information processing apparatus for executing an information process while transmitting and receiving data to and from the information terminal device in response to a request from the information terminal device, wherein
the information processing apparatus comprises:
a first communication circuit configured to perform wireless communication;
an output circuit configured to output an image; and
a controller configured to control the output circuit to output an image containing a code symbol which can be optically read, the code symbol indicating connection information for wireless connection from the information terminal device to the first communication circuit and identification information for identifying the information processing apparatus for data transmission, and
the information terminal device comprises:
a second communication circuit configured to perform wireless communication;
a reader configured to optically read the code symbol; and
request circuit configured to:
enable the second communication circuit to establish wireless connection with the first communication circuit using the connection information indicated by the read code symbol in response to reading of the code symbol by the reader after execution of the information process is instructed, and
request execution of the information process using the identification information indicated by the read code symbol.

9. An information terminal device, which makes up an information processing system together with an information processing apparatus, the information terminal device comprising:
a second communication circuit configured to perform wireless communication:
a reader configured to optically read a code symbol; and
a request circuit configured to:
enable the second communication module to establish wireless connection with a first communication circuit of the information processing apparatus using connection information indicated by the read code symbol in response to reading of the code symbol by the reader after execution of an information process is instructed, and
request execution of the information process using the identification information indicated by the read code symbol, wherein
the information processing apparatus is configured to execute an information process while transmitting and receiving data to and from the information terminal device in response to a request from the information terminal device, and comprises:
the first communication circuit configured to perform wireless communication;
an output circuit configured to output an image; and
a controller configured to control the output circuit to output an image containing the code symbol which can be optically read, the code symbol indicating connection information for wireless connection from the information terminal device to the first communication circuit and identification information for identifying the information processing apparatus for data transmission.

10. The information terminal device according to claim 9, further comprising a display, wherein the request circuit is configured to cause the display to display a message providing instructions to guide the use of the reader to read the code symbol.

11. The information terminal device according to claim 9, wherein the reader includes a camera.

12. The information terminal device according to claim 9, further comprising a display, wherein the request circuit is configured to cause the display to display an error message when the second communication circuit is unable to establish wireless communication with the first second communication circuit for a time greater than a predetermined time.

13. The information terminal device according to claim 12, wherein when the display displays an error message, the display prompts a user to retry establishing wireless communication.

14. The information terminal device according to claim 9, further comprising a designation screen, wherein the request circuit is configured to cause the designation screen to display a content of a job to be executed by the information processing apparatus.

15. An information processing method by an information processing apparatus for executing an information process for controlling an information terminal device which constitutes an information processing system with the information processing apparatus,
the information processing apparatus for executing an information process while transmitting and receiving data to and from the information terminal device in response to a request from the information terminal device, comprises: a first communication circuit configured to perform wireless communication; and an output circuit configured to output an image;
the information terminal device comprises: a second communication circuit configured to perform wireless communication; and a reader configured to optically read the code symbol,
the method comprising:
enabling the second communication circuit to establish wireless connection with the first communication circuit using connection information indicated by the read code symbol in response to reading of a code symbol by the reader after execution of an information process is instructed, and requesting execution of the information process using the identification information indicated by the read code symbol through the wireless connection;
and
controlling the output circuit to output an image containing the code symbol which can be optically read, the code symbol indicating connection information for wireless connection from the information terminal device to the first communication circuit and identification information for identifying the information processing apparatus for data transmission.
